(19) United States
(12) Patent Application Publication
(10) Pub. No.: US 2016/0140597 A1
(43) Pub. Date: May 19, 2016

(54) SERVICE PROVIDER TERMINAL AND METHODS OF OPERATING A SERVICE PROVIDER TERMINAL

(71) Applicant: ADVANCED TELLER SOLUTIONS PTY LTD, New South Wales (AU)

(72) Inventors: John Samuel Anthony, Caringbah (AU); Rowland Charles Chalmers, Caringbah (AU); James Neill Adams, Cronulla (AU); Anthony Terrence Clark, Nunderi (AU)

(21) Appl. No.: 14/899,990

(22) PCT Filed: Jun. 17, 2014
(86) PCT No.: PCT/AU2014/000627

§ 371 Date: Dec. 18, 2015

(30) Foreign Application Priority Data
Jun. 18, 2013 (AU) 2013902195

(51) Int. Cl. G06Q 30/02; G06Q 20/10

(52) U.S. Cl. CPC G06Q 30/0226; G06Q 20/1085

(57) ABSTRACT

Described herein are service provider terminals and methods of operating service provider terminals. The service provider terminals include a member ID input module for receiving data indicative of a user member ID associated with a loyalty program, wherein the user accumulates a plurality of member points through performing one or more point earning activities offered by the loyalty program. The service provider terminals further include a service provider input module for receiving data indicative of a user service provider ID associated with a service account. Furthermore, the service provider terminals include a computation module for reducing the member points by a predetermined number of points.

### FIELD OF THE INVENTION

The present invention relates to service provider terminals and methods of operating service provider terminals.

Embodiments of the invention have been particularly developed for service provider terminals such as automatic teller machines (ATMs), automated banking machines (ABMs) and the like. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Reference throughout the specification will be made to service provider terminals. Such references are intended to include, ATMs, ABMs, cash machines and the like. A service provider terminal is defined as a terminal which provides particular services to a user of that terminal. For example, ATMs, ABMs, cash machines and the like provide users with access their bank accounts in order to perform various financial transactions.

Service provider terminals such as ATMs are known devices which allow users to perform various financial transactions such as accessing their bank accounts to make cash withdrawals. There are generally two types of ATMs: ATMs owned by financial institutions; and ATMs owned by independent providers.

It is not uncommon for users to be charged ATM service or usage fees for using ATMs. In most cases, such service or usage fees are only charged to users who are not customers of the particular financial institution who owns the ATM that the user is accessing. For example, a user who is a customer of financial institution A will be charged a service or usage fee for using an ATM owned by financial institution B to access their funds.

In other cases where ATMs are owned by independent providers, that is non-financial institutions, such service or usage fees are charged to all users. Independently owned ATMs, such as CashConnect ATMs and BankTech ATMs, can be found in many locations including clubs, bars, pubs, convenient stores, supermarkets, shopping centres and the like.

In many circumstances, the charge of service or usage fees acts as a disincentive to users from using a particular service provider terminal. This is particularly the case where a user has the option of using another service provider terminal where such service or usage fees would not be charged.

As an example, a user may wish to make a cash withdrawal from an ATM located within a club. Upon discovering that the ATM in the club is independently owned and as such would charge a service or usage fee, the user may leave the club to find an ATM which would not charge a service or usage fee such as an ATM owned by a financial instruction for which the user is a customer. Similarly, if the user discovers that the ATM in the club is owned by a financial institution for which the user is not a customer and would therefore be charged a service or usage fee, the user may again leave the club to find an ATM which would not charge a service or usage fee. Whilst it may be inconvenient for the user to leave the club, the benefit of leaving the club is viewed as a cost saving to the user.

In light of the disincentive which may be experienced by a user being confronted with a service or usage charge fee, there is a desire for a service provider terminal and method of operating a service provider terminal whereby such service or usage fees are reduced or eliminated. ATMs or methods of operating ATMs whereby service or usage fees are reduced or eliminated would encourage users to use those ATMs.

### SUMMARY OF THE INVENTION

It is an object of the present invention to overcome or ameliorate at least one of the disadvantages of the prior art, or to provide a useful alternative.

Embodiments of the present invention seek to provide service provider terminals and methods of operating service provider terminals whereby service or usage fees are reduced or eliminated.

More specifically, embodiments of the present invention seek to provide service provider terminals and methods of operating service provider terminals whereby service or usage fees, which would otherwise be charged to a user, are reduced or eliminated through redemption of the user's member points associated with a loyalty program in which the user is a member. In this manner, embodiments of the present invention seek to provide service provider terminals and methods of operating service provider terminals that allow a user to redeem member points for the services provided by those service provider terminals, wherein the user's member points are associated with a loyalty program in which the user is a member.

One embodiment provides a service provider terminal including:

a member ID input module for receiving data indicative of a user member ID associated with a loyalty program, wherein the user accumulates a plurality of member points through performing one or more point earning activities offered by the loyalty program;

a service provider input module for receiving data indicative of a user service provider ID associated with a service account; and

a computation module for reducing the member points by a predetermined number of points, if the number of member points is greater than or equal to the predetermined number of points, thereby to allow the user to proceed with a service transaction provided by the service provider terminal without a monetary service fee being charged to the service account.

One embodiment provides a service provider terminal, wherein the computation module automatically reduces the member points by the predetermined number of points.

One embodiment provides a service provider terminal, including a selection interface for providing the user with an option of reducing the member points by the predetermined number of points.

One embodiment provides a service provider terminal, wherein if the user chooses not to reduce the member points by the predetermined number of points, the computation module applies a monetary service fee to the service account to allow the user to proceed with the service transaction.

One embodiment provides a service provider terminal, including a selection interface for providing the user with an option of accepting a monetary service fee to be charged to the service account.

One embodiment provides a service provider terminal, wherein if the user accepts the monetary service fee to be charged to the service account, the computation module applies the monetary service fee to the service account to allow the user to proceed with the service transaction.

One embodiment provides a service provider terminal, wherein if the user declines the monetary service fee to be charged to the service account, the computation module denies the user permission to proceed with the service transaction.

One embodiment provides a service provider terminal, wherein if the number of member points is less than the predetermined number of points, the computation module applies a monetary service fee to the service account to allow the user to proceed with the service transaction.

One embodiment provides a service provider terminal, wherein if the number of member points is less than the predetermined number of points, a selection interface provides the user with an option to accept a monetary service fee to be applied to the service account by the computation module to allow the user to proceed with the service transaction.

One embodiment provides a service provider terminal, wherein the computation module includes a points module for retrieving the member points from a member points database of a loyalty program system.

One embodiment provides a service provider terminal, wherein the computation module includes a service account module for communicating with a service account database of a service account system.

One embodiment provides a service provider terminal, including a display interface.

One embodiment provides a service provider terminal, including a selection interface.

One embodiment provides a method of operating a service provider terminal, the method including:

receiving data indicative of a user member ID associated with a loyalty program, wherein the user accumulates a plurality of member points through performing one or more point earning activities offered by the loyalty program;

receiving data indicative of a user service provider ID associated with a service account; and

reducing the member points by a predetermined number of points, if the number of member points is greater than or equal to the predetermined number of points, thereby to allow the user to proceed with a service transaction provided by the service provider terminal without a monetary service fee being charged to the service account.

One embodiment provides a method of operating a service provider terminal, wherein the member points is automatically reduced by the predetermined number of points.

One embodiment provides a method of operating a service provider terminal, including providing the user with an option of reducing the member points by the predetermined number of points.

One embodiment provides a method of operating a service provider terminal, wherein if the user chooses not to reduce the member points by the predetermined number of points, a monetary service fee is charged to the service account to allow the user to proceed with the service transaction.

One embodiment provides a method of operating a service provider terminal, including providing the user with an option of accepting a monetary service fee to be charged to the service account.

One embodiment provides a method of operating a service provider terminal, wherein if the user accepts the monetary service fee to be charged to the service account, the monetary service fee is charged to the service account to allow the user to proceed with the service transaction.

One embodiment provides a method of operating a service provider terminal, wherein if the user declines the monetary service fee to be charged to the service account, the user is denied permission to proceed with the service transaction.

One embodiment provides a method of operating a service provider terminal, wherein if the number of member points is less than the predetermined number of points, a monetary service fee is charged to the service account to allow the user to proceed with the service transaction.

One embodiment provides a method of operating a service provider terminal, wherein if the number of member points is less than the predetermined number of points, the user is provided with an option to accept a monetary service fee to be charged to the service account to allow the user to proceed with the service transaction.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 schematically illustrates a service provider terminal according to an embodiment of the present invention;

FIG. 2A illustrates a method of operating a service provider terminal according to an embodiment of the invention;

FIG. 2B illustrates a method of operating a service provider terminal according to a second embodiment;

FIG. 2C illustrates a method of operating a service provider terminal according to a third embodiment; and

FIG. 2D illustrates a method of operating a service provider terminal according to a fourth embodiment.

### DETAILED DESCRIPTION

The following description and Figures make use of reference numerals to assist the addressee understand the structure and function of the illustrated embodiments. Like reference numerals are used in different embodiments to designate features having the same or similar function and/or structure.

The drawings need to be viewed as a whole and together with the associated text in this specification. In particular, some of the drawings selectively omit features to provide greater clarity about the specific features being described. While this is done to assist the reader, it should not be taken that those features are not disclosed or are not required for the operation of the relevant embodiment.

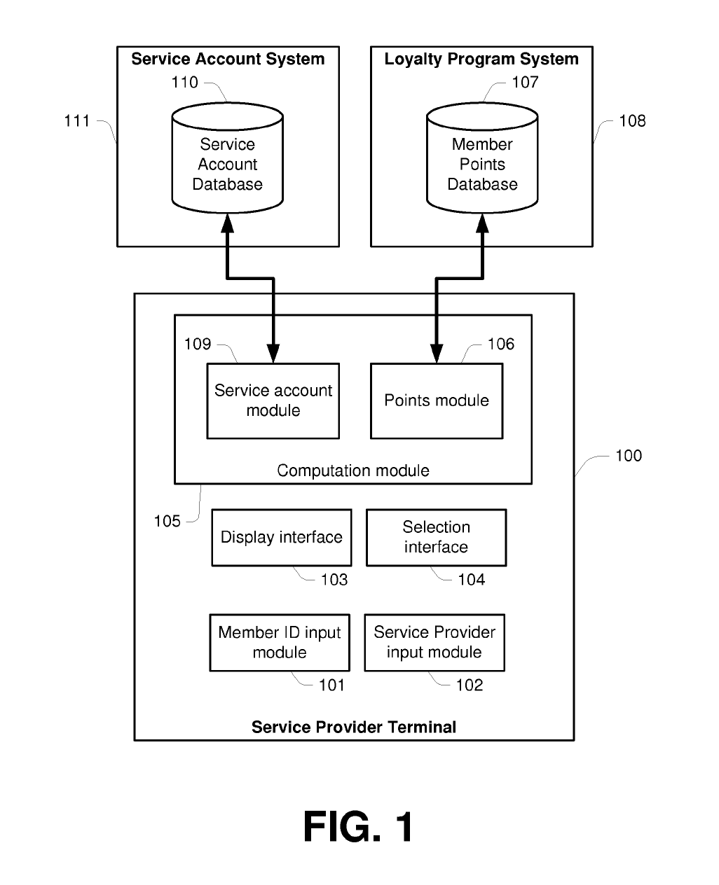

FIG. 1 illustrates a service provider terminal 100 according to an embodiment of the present invention. In this embodiment, service provider terminal 100 includes a member ID input module 101 for receiving data indicative of a user member ID associated with a loyalty program.

Clubs, bars, pubs, convenient stores, supermarkets, shopping centres and the like often offer users memberships to loyalty programs. Upon joining a loyalty program, users are issued a unique member ID number and, in some cases, a member ID card. Personal information such as the user's name, address, contact number, and various other information is stored on databases of systems associated with the loyalty program.

Loyalty programs typically allow users to accumulate member points through performing various point earning activities offered by the loyalty program. The point earning activities vary but generally include, but are not limited to, the purchase of goods and services. The number of points a user earns through performing a point earning activity can vary. For example, a dollar spent on purchasing a good or service could earn a user 1 point. On the other hand, the user may be required to spend 5 dollars on purchasing a good or service to earn 1 point. It will be appreciated that the process of earning points can vary between loyalty programs. It will also be appreciated that the process of earning points can vary between point earning activities within the same loyalty program. The number of points associated with the user is stored against the user's member ID in the loyalty program system's database.

A user may redeem accumulated member points for various items as permitted by the loyalty program. Referring to clubs as an example, a user's club member points are redeemable for food and beverages at the club.

The perceived value of items redeemable by a user varies. In some instances, a user may wish to wait for their member points to accumulate to a certain number before they redeem an item that is perceived to have a higher value than an item which could be redeemed for less member points. In some cases, users may perceive little value in the items permitted to be redeemed by the loyalty program, and as a consequence perceive little value in the member points themselves. Accordingly, there is a desire to increase the perceived value of loyalty program member points.

In this regard, described herein are service provider terminals and methods of operating service provider terminals. In particular, described herein are service provider terminals and methods of operating service provider terminals whereby service or usage fees, which would otherwise be charged to a user, are reduced or eliminated through redemption of a user's member points associated with a loyalty program in which the user is a member. In this manner, the service provider terminals and methods of operating service provider terminals described herein allow a user to redeem member points for the services provided by those service provider terminals, wherein the user's member points are associated with a loyalty program in which the user is a member.

Referring again to FIG. 1, member ID input module 101 is configured to receive data indicative of the user member ID. In one embodiment, member ID input module 101 is configured to receive data indicative of the user member ID via a member ID card. For example, a user swipes, inserts, taps or otherwise inputs their member ID card at service provider terminal 100, and member ID input module 101 reads the user member ID from the member ID card.

In other embodiments, the member ID input module is configured to receive data indicative of the user member ID, for example, via input from a keypad. For example, a user enters their member ID number via the keypad at service provider terminal 100 and member ID input module 101 reads the member ID number as it is being entered by the user.

In other embodiments, the member ID input module is configured to receive data indicative of the user member ID by other technological means. For example, the user member ID may be provided via direct user input, the provision of a physical token (read via wireless, magnetic, or other means), via interaction with a secondary device (for example a mobile phone, mobile device or other remote device that executes software), and so on.

It will be appreciated by those skilled in the art that the means by which the member ID input module receives data indicative of the user member ID are not strictly limited to the examples provided herein.

Service provider terminal 100 includes one or more processors and is configured to access data from a loyalty program system 108 using the unique user member ID number received by member ID input module 101. In this manner, service provider terminal 100 is configured to access a user's personal information, such as the user's name, address, contact number, and various other information, as stored on one or more databases associated with loyalty program system 108. The number of member points associated with a user is stored on a member points database 107 associated with loyalty program system 108. Service provider terminal 100 is configured to access member points database 107 to obtain data relating to the number of member points the user has based on the input received at member ID input module 101. It will be appreciated that, in some embodiments, member points databases 107 includes one or more databases.

In some embodiments, member ID input module 101 is internally integrated with service provider terminal 100. In other embodiments, member ID input module 101 is an external unit coupled to service provider terminal 100.

Service provider terminal 100 also includes a service provider input module 102 for receiving data indicative of a user service provider ID associated with a service account. In one embodiment, service provider input module 102 is configured to receive data indicative of the user service provider ID via a service provider ID card. For example, a user swipes, inserts, taps or otherwise inputs their service provider ID card at service provider terminal 100, and service provider input module 102 reads the user service provider ID from the service provider ID card. Referring to an ATM as an example, a user swipes, inserts, taps or otherwise inputs their ATM card at the ATM, and the service provider input module reads the card to obtain the account ID or account number associated with the user's bank account at a financial institution.

In the ATM example, it will be appreciated that the service provider ID card need not be an ATM card associated with a specific financial institution. For example, in one embodiment, the service provider ID card is an ID card associated with an intermediary provider. In this example, a user swipes, inserts, taps or otherwise inputs their intermediary provider ID card at the ATM, and service provider input module 102 reads the card to obtain the provider ID number associated with the user's service account held with the intermediary provider. In one embodiment, the user's service account associated with the intermediary provider is in turn associated with the user's bank account at a financial institution.

In some embodiments, the service account is a user's bank account or financial account. However, in other embodiments, the service account is an account held with the intermediary provider. In some embodiments, the intermediary account is in turn associated with a user's bank account or financial account.

In other embodiments, service provider input module 102 is configured to receive data indicative of the user service provider ID, for example, via input from a keypad. For example, a user enters their service provider ID number via a keypad at service provider terminal 100 and service provider input module 102 reads the service provider ID number as it is being entered by the user.

In other embodiments, the service provider input module is configured to receive data indicative of the user service provider ID by other technological means. For example, the user service provider ID may be provided via direct user input, the provision of a physical token (read via wireless, magnetic, or other means), via interaction with a secondary device (for example a mobile phone, mobile device or other remote device that executes software), and so on.

It will be appreciated by those skilled in the art that the means by which the service provider input module receives data indicative of the user service provided ID are not strictly limited to the examples provided herein.

Service provider terminal 100 includes one or more processors and is configured to access data from a service account system 111 using the unique user service provider ID number received by service provider input module 102. In this manner, service provider terminal 100 is configured to access data associated with a user's service account. In one embodiment, such data is store in a service account database 110. Using an ATM as an example of a service provider terminal, the ATM is configured to access a user's bank account details including the user's account balance.

Service provider terminal 100 further includes a computation module 105. Computation module 105 includes one or more processors for processing data. Computation module 105 includes a points module 106. Points module 106 includes one or more processors for processing data and is configured to communicate with member points database 107 associated with loyalty program system 108. Points module 106 accesses member points database 107 to retrieve data relating to the number of member points a user currently possess. The user's member points data is exchanged over one or more servers and provided to points module 106. In this manner, a service provider terminal is able to determine the number of member points a user has for a particular loyalty program. For example, a user of service provider terminal 100 provides their user member ID, either via a member ID card or input to a keypad, and member ID input module receives this user member ID. This user member ID is associated with a loyalty program. Based on the user member ID provided by the user, points module 106 obtains the number of member points the user possess with the loyalty program as store on the member points database 107 of the loyalty program system 108.

Computation module 105 also includes a service account module 109. Service account module 109 includes one or more processors and is configured to communicate with service account database 110 associated with service account system 111. Data from the service account database is exchanged over one or more servers and provided to service account module 109. Referring to an ATM as an example of service provider terminal 100, service account module 109 communicates with service account database 110 to obtain information relating to the user's bank account at a financial institution.

Computation module 105 is configured to determine whether the number of member points is greater, equal to, or less than a predetermined number of points. The predetermined number of points is the number of points required to allow the user to proceed with a service transaction provided by service provider terminal 100 without a monetary service fee being charged to the service account.

Computation module 105 is further configured to reduce the user's member points by the predetermined number of points, if the number of member points is greater than or equal to the predetermined number of points, thereby to allow the user to proceed with the service transaction provided by service provider terminal 100 without a monetary service fee being charged to the user's service account. To reduce the user's member points, points module 106 obtains member points data from member points database 107, computation module 105 then subtracts the predetermined number of points from the user's number of member points thereby to modify the user's member points data stored on member points database 107.

In one embodiment, computation module 105 automatically reduces the member points by the predetermined number of points if it is determined that the number of member points is greater than or equal to the predetermined number of points.

Computation module 105 uses its one or more processors to process data received from member points database 107 and service account database 110.

In some embodiments, data from member points database 107 and service account database 110 is processed by one or more processors of the service provider terminal. For example, the data is processed by one or more processors of the computation module. In another embodiment, the data is processed by one or more processors of the computation module in combination with one or more processors of the points module and/or service account module. In a further embodiment, the data is process by one or more processors of the points module and/or service account module.

In other embodiments, data from member points database 107 and service account database 110 is processed, in part, by one or more processors external to service provider terminal 100 prior to being received at the service provider terminal. In some embodiments, data from member points database 107 and service account database 110 is processed in full by one or more processors external to service provider terminal 100 prior to being received at the service provider terminal.

Processing data as known in the context of computer technology and as herein described includes, receiving data, providing data output, transmitting data, manipulating data, modifying data, analysing data, and otherwise performing operations on data.

Service provider terminal further includes a display interface 103 and a selection interface 104.

In one embodiment, selection interface 104 provides the user with an option of reducing the member points by the predetermined number of points. If the user chooses to reduce the member points by the predetermined number of points, computation module 105 modifies the user's member points data stored on member points database 107 thereby to reduce the member points by the predetermined number of points and allow the user to proceed with the service transaction. In another embodiment, if the user chooses not to reduce the member points by the predetermined number of points, computation module 105 applies a monetary service fee to the user's service account to allow the user to proceed with the service transaction. To apply a monetary service fee to the user's service account, service account module 109 communicates with service account database 110 to obtain the user's account balance, and computation module 105 decreases the user's account balance by the service fee amount. In this manner, computation module 105 modifies data stored on service account database 110. Where a service fee is to be applied to a user's service account, it will be appreciated, that user's account balance is decreased by the service fee amount at any time prior to termination of the service transaction.

In another embodiment, selection interface 104 provides the user with an option of accepting a monetary service fee to be charged to the service account. In one embodiment, if the user accepts the monetary service fee to be charged to the service account, computation module 105 applies the monetary service fee to the user's service account to allow the user to proceed with the service transaction. In another embodiment, if the user declines the monetary service fee to be charged to the service account, computation module 105 denies the user permission to proceed with the service transaction. In this case, the service transaction will simply terminate.

If computation module 105 determines that the number of member points is less than the predetermined number of points, the computation module applies a monetary service fee to the service account to allow the user to proceed with the service transaction. In another embodiment where computation module 105 determines that the number of member points is less than the predetermined number of points, selection interface 104 provides the user with an option to accept a monetary service fee to be applied to the service account by computation module 105 to allow the user to proceed with the service transaction.

In another embodiment, if computation module 105 determines that the number of member points is less than the predetermined number of points, selection interface 104 provides the user with an option to reduce the member points by a number of points which is less than the predetermined number of points in combination with accepting a reduced monetary service fee to be charged to the service account. The reduced monetary service fee being less than the full monetary service fee that would be charged to the service account in circumstances where the user has zero member points. For example, say a service transaction cost is either a $2.00 service fee or 200 member points. In this particular embodiment, if a user has 100 member points, the user would be provided with an option to reduce their member points by one or more member points up to a maximum of 100 member points in combination with accepting a reduced monetary service fee. For example, the user could choose to reduce their member points by 100 member points in combination with accepting a reduced monetary service fee of $1.00 to be charged to the service account.

Service provider terminal 100 operates to facilitate communication with two systems. In particular, service provider terminal 100 operates to facilitate communication with loyalty program system 108 and service account system 111. Communication with these two systems via service provider terminal 100 includes retrieving data stored on one or more respective databases and modifying data stored on the one or more respective databases.

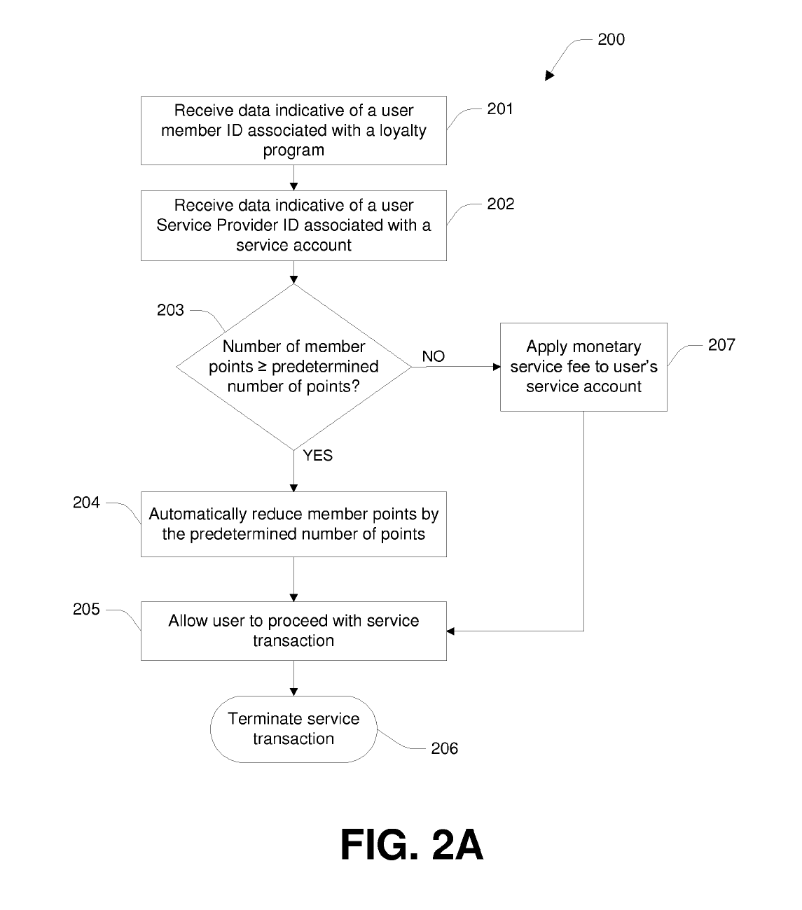

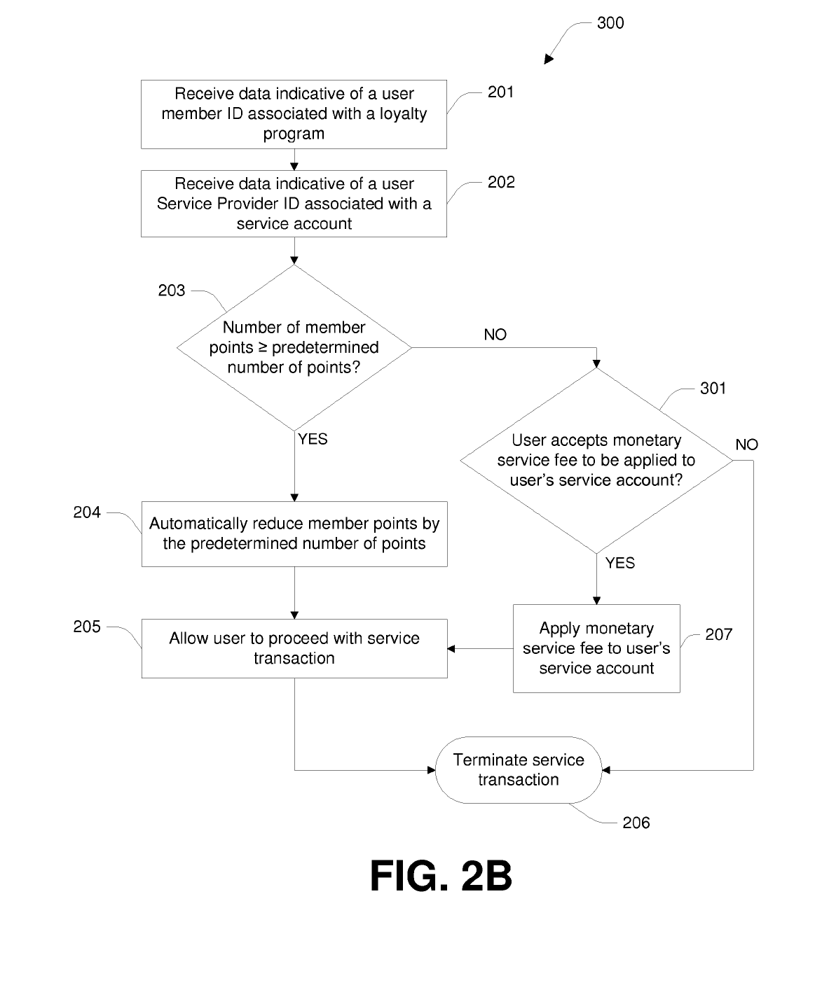

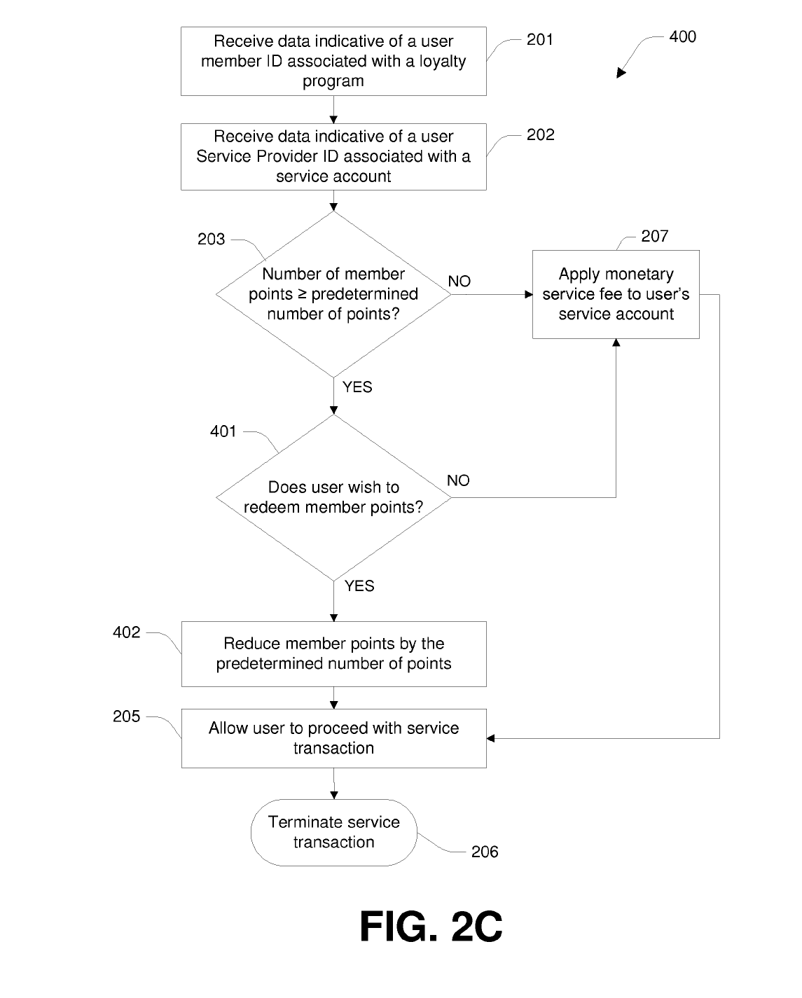

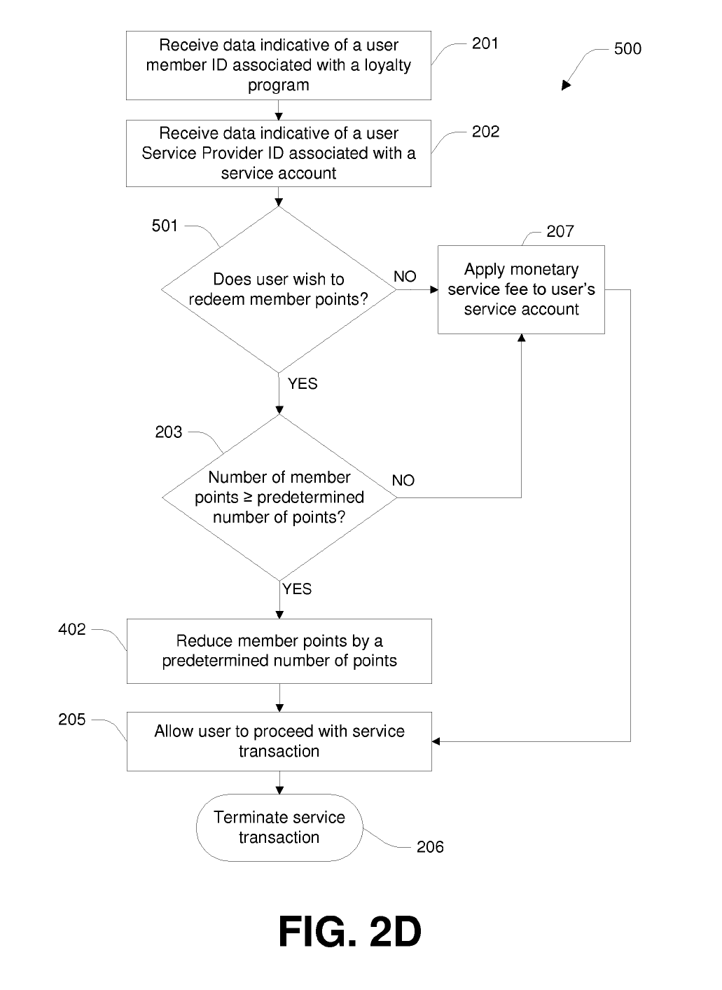

FIG. 2A illustrates a method 200 of operating service provider terminal 100 according to an embodiment of the invention. Member ID input module 101 receives data indicative of a user member ID associated with a loyalty program 201. Service provider input module 102 then receives data indicative of a user service provider ID associated with a service account 202. Computation module 105 determines whether the number of member points is greater, equal to, or less than a predetermined number of points 203. If the number of member points is greater than or equal to the predetermined number of points, computation module 105 automatically reduces the member points by the predetermined number of points 204, and the user is allowed to proceed with a service transaction 205 provided by service provider terminal 100 without a monetary service fee being charged to the service account. The service transaction then terminates 206.

On the other hand, if the number of member points is less than the predetermined number of points, computation module 105 applies a monetary service fee to the user's service account 207 and allows the user to proceed with the service transaction 205. The service transaction then terminates 206.

FIG. 2B illustrates a method 300 of operating service provider terminal 100 according to a second embodiment. Method 300 is similar to method 200, however, if computation module 105 determines that the number of member points is less than the predetermined number of points, selection interface 104 provides the user with an option of accepting a monetary service fee to be charged to the service account. If the user accepts the monetary service fee being charged to the service account, computation module 105 applies the monetary service fee to the user's service account 207 to allow the user to proceed with the service transaction 205. The service transaction then terminates 206.

If the user declines the monetary service fee to be charged to the service account, computation module 105 denies the user permission to proceed with the service transaction, and service transaction terminates 206.

FIG. 2C illustrates a method 400 of operating service provider terminal 100 according to a third embodiment. Member ID input module 101 receives data indicative of a user member ID associated with a loyalty program 201. Service provider input module 102 then receives data indicative of a user service provider ID associated with a service account 202. Computation module 105 determines whether the number of member points is greater, equal to, or less than a predetermined number of points 203. If the number of member points is greater than or equal to the predetermined number of points, selection interface 104 provides the user with an option of reducing the member points by the predetermined number of point. That is, the user is provided with the option of redeeming their member points 401.

If the user chooses to reduce the member points by the predetermined number of points, computation module 105 reduces the member points by the predetermined number of points 402 and allows the user to proceed with the service transaction 205. The service transaction then terminates 206.

On the other hand, if the user chooses not to reduce the member points by the predetermined number of points, computation module 105 applies a monetary service fee to the user's service account 207 to allow the user to proceed with the service transaction 205. The service transaction then terminates 206.

If the number of member points is less than the predetermine number of points, computation module 105 applies a monetary service fee to the user's service account 207 and allows the user to proceed with the service transaction 205. The service transaction then terminates 206.

FIG. 2D illustrates a method 500 of operating service provider terminal 100 according to a fourth embodiment. Method 500 is similar to method 400. However, in method 500, selection interface 104 provides the user with an option of redeeming their member points 501, prior to computation module 105 determining whether the number of member points is greater, equal to, or less than a predetermined number of points 203.

In embodiments of the invention, one or more processors of the service provider terminal transmit one or more request for data to one or more servers. The one or more servers then return data in response to the request.

Embodiments of the invention make use of one or more processors to process data. Embodiments of the invention also make use of and one or more servers to exchange data. Embodiments of the invention exchange data over one or more networks.

### EXAMPLES

As an example, existing providers of member loyalty programs inter alia of the Registered Club industry includes major manufacturers such as IDG, Aristocrat and E-BET and Independent Gaming Services. All systems are identical. Members of these loyalty programs accumulate member points through point earning activities such as purchasing food and beverages in the club and engaging in gaming activities such as playing poker machines.

These points are redeemable for goods and or promotions offer by the club or network of clubs associated with the loyalty program. The perceived value of these redeemable goods varies between users.

These clubs generally include one or more independently owned service provider terminals such as ATMs. The independently owned ATMs charge users a service fee for using the ATMs, such as when making cash withdrawals. These service fees acts as a disincentive to users from using these ATMs. This is particularly the case where the user has to option of leaving the club to find an ATM which would not charge a service fee such as an ATM owned by a financial instruction for which the user is a customer. Leaving the club may be seen as inconvenient to the user. However, the benefit of leaving the club is viewed as a cost saving to the user. On the other hand, the user may be discouraged from making a cash withdrawal altogether.

In this particular circumstance, if the ATM located in the club was a service provider terminal according to the present invention, the user would be able to redeem their club member points for using the ATM without the service fee being charged to their bank account. This increases the likelihood that the user will use the ATM and stay in the club, rather than leave the club to find an alternate ATM. This also increases the perceived value of the user's club member points.

As a more specific example, a user may approach an ATM in accordance with the present invention. Upon swiping his or her member card, the user's club member points are automatically reduced by a number of predetermined points. This predetermined number of points is the number of points required to allow the user to use the ATM without a service fee being charged. Once the user's club member points are automatically reduced by a number of predetermined points, the user is free to use the ATM without any fees being charged for using the service. These ATM in clubs would receive higher usage than the typical ATMs which charge service fees. Additionally, the clubs themselves would receive higher in-house spend due to the increased likelihood of cash withdrawals being conducted in-house.

Embodiments of the invention are also applicable to any retail use, such as supermarkets which include user loyalty programs. Loyalty programs associated with supermarkets allow members to accumulate member points through purchasing goods and services from eligible retailers. Such retailers include, but are not limited to, the supermarkets themselves, liquor stores associated with the supermarkets, and service stations associated with the supermarkets. It will be appreciated that retailers in addition to these may be considered as eligible retailers.

Member points accumulated through supermarket loyalty programs are redeemable for certain goods and services, including gift vouchers and the like. In some cases, members of supermarket loyalty programs are also eligible to receive promotional discounts which non-members are not eligible to receive.

It is common for independently owned service provider terminals such as ATMs, to be located in the vicinity of retailers such as supermarkets, liquor stores associated with the supermarkets, or service stations associated with the supermarkets. These independently owned ATMs charge users a service fee for using the ATMs, such as when making cash withdrawals. These service fees acts as a disincentive to users from using these ATMs. However, if an ATM located in the vicinity of these retailers was a service provider terminal according to the present invention, a user would be able to redeem their supermarket member points for using the ATM without a service fee being charged to their bank account. The option of redeeming supermarket member points for using the ATM increases the likelihood that the user will use the ATM and stay in the vicinity of the retailers. With users remaining in the vicinity of the retailers, this not only results in increased usage of the ATMs, retailers in that vicinity will also experience increased business. The option of redeeming supermarket member points for using an ATM that would otherwise charge a service fee also increases the user's perceived value of their supermarket member points.

In the above examples and embodiments, references to ATMs which charge users a service or usage fee for using the particular ATMs are not limited to independently owned ATMs or independently owned service provider terminals. For example, in some instances, an ATM is owned by a financial institution other than the financial institution for which the user is a customer. In such an instance, the user would be charged a service or usage fee for using the ATM owned by a financial institution for which they are not a customer. As a more specific example, a user who is a customer of financial institution A will be charged a service or usage fee for using an ATM owned by financial institution B to access their funds. Service provider terminals, such as ATMs, implemented with technology of the invention as herein described facilitate the redemption of member points associated with a relevant loyalty program or rewards program without the user being charged a service fee or usage fee.

The above examples are provided for illustrative purposes and are by no means suggestive of the only circumstances where service provider terminals and methods of operating service provider terminals of the present invention are applicable. It will be appreciated that service provider terminals and methods of operating service provider terminals of the present invention are applicable to any businesses which have an associated loyalty program, and which include service provider terminals or include service provider terminals in their vicinity.

### CONCLUSIONS AND INTERPRETATION

It will be appreciated that the disclosure above provides various significant service provider terminals and methods of operating service provider terminals. In particular, the disclosure above provides various significant service provider terminals and methods of operating service provider terminals whereby service or usage fees, which would otherwise be charged to a user, are reduced or eliminated through redemption of a user's member points associated with a loyalty program in which the user is a member. In this manner, the service provider terminals and methods of operating service provider terminals allow a user to redeem member points for the services provided by those service provider terminals, wherein the user's member points are associated with a loyalty program in which the user is a member.

Thus, embodiments of the invention provide service provider terminals that will experience increased usage due to the reduction and/or elimination of service or usage fees. Furthermore, businesses which include such service provider terminals and/or businesses which include such service provider terminals within their vicinity will experience increased business, such as in the form of increased revenues, due to the increased usage of the service provider terminals.

A technical problem arises in the reduced usage of service provider terminals which charge users a service or usage fee for making use of the services provided by the terminals. The charge of service or usage fees acts as a disincentive to users from using particular service provider terminals.

A technical solution provided by embodiments of the invention include service provider terminals and methods of operating service provider terminals whereby service or usage fees, which would otherwise be charged to a user, are reduced or eliminated.

Embodiments of the present invention relate to advancement and improvements in computer technology, and in particular to improvements in terminal technology, for example ATM terminal technology and functionality.

Throughout the specification the term “service account” includes, but is not limited to, a bank account, a financial account and an intermediary account. An intermediary account is an account held with an intermediary provider. An intermediary account may in turn be associated or otherwise linked to a bank account or a financial account.

The terms “loyalty points” and “reward points” as used throughout the specification are intended to have the same meaning in the context of the present invention. Similarly, the terms “loyalty program” and “rewards program” are intended to have the same meaning in the context of the present invention. The terms “loyalty program” and “rewards program” are intended to refer to any program which allows a user to accumulate points through performing various point earning activities offered by the relevant program. The terms “loyalty points” and “reward points” refer to the points earned by a user through performing relevant point earning activities.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A service provider terminal including:
a member ID input module for receiving data indicative of a user member ID associated with a loyalty program, wherein the user accumulates a plurality of member points through performing one or more point earning activities offered by the loyalty program;
a service provider input module for receiving data indicative of a user service provider ID associated with a service account; and
a computation module for reducing the member points by a predetermined number of points, if the number of member points is greater than or equal to the predetermined number of points, thereby to allow the user to proceed with a service transaction provided by the service provider terminal without a monetary service fee being charged to the service account.

2. A service provider terminal according to claim 1, wherein the computation module automatically reduces the member points by the predetermined number of points.

3. A service provider terminal according to claim 1, including a selection interface for providing the user with an option of reducing the member points by the predetermined number of points.

4. A service provider terminal according to claim 3, wherein if the user chooses not to reduce the member points by the predetermined number of points, the computation module applies a monetary service fee to the service account to allow the user to proceed with the service transaction.

5. A service provider terminal according to claim 1, including a selection interface for providing the user with an option of accepting a monetary service fee to be charged to the service account.

6. A service provider terminal according to claim 5, wherein if the user accepts the monetary service fee to be charged to the service account, the computation module applies the monetary service fee to the service account to allow the user to proceed with the service transaction.

7. A service provider terminal according to claim 5, wherein if the user declines the monetary service fee to be charged to the service account, the computation module denies the user permission to proceed with the service transaction.

8. A service provider terminal according to claim 1, wherein if the number of member points is less than the predetermined number of points, the computation module applies a monetary service fee to the service account to allow the user to proceed with the service transaction.

9. A service provider terminal according to claim 1, wherein if the number of member points is less than the predetermined number of points, a selection interface provides the user with an option to accept a monetary service fee to be applied to the service account by the computation module to allow the user to proceed with the service transaction.

10. A service provider terminal according to claim 1, wherein the computation module includes a points module for retrieving the member points from a member points database of a loyalty program system.

11. A service provider terminal according to claim 1, wherein the computation module includes a service account module for communicating with a service account database of a service account system.

12. (canceled)

13. (canceled)

14. A method of operating a service provider terminal, the method including:
receiving data indicative of a user member ID associated with a loyalty program, wherein the user accumulates a plurality of member points through performing one or more point earning activities offered by the loyalty program;
receiving data indicative of a user service provider ID associated with a service account; and
reducing the member points by a predetermined number of points, if the number of member points is greater than or equal to the predetermined number of points, thereby to allow the user to proceed with a service transaction provided by the service provider terminal without a monetary service fee being charged to the service account.

15. A method according to claim 14, wherein the member points is automatically reduced by the predetermined number of points.

16. A method according to claim 14, including providing the user with an option of reducing the member points by the predetermined number of points.

17. A method according to claim 16, wherein if the user chooses not to reduce the member points by the predetermined number of points, a monetary service fee is charged to the service account to allow the user to proceed with the service transaction.

18. A method according to claim 14, including providing the user with an option of accepting a monetary service fee to be charged to the service account.

19. A method according to claim 18, wherein if the user accepts the monetary service fee to be charged to the service account, the monetary service fee is charged to the service account to allow the user to proceed with the service transaction.

20. A method according to claim 18, wherein if the user declines the monetary service fee to be charged to the service account, the user is denied permission to proceed with the service transaction.

21. A method according to claim 14, wherein if the number of member points is less than the predetermined number of points, a monetary service fee is charged to the service account to allow the user to proceed with the service transaction.

22. A method according to claim 14, wherein if the number of member points is less than the predetermined number of points, the user is provided with an option to accept a monetary service fee to be charged to the service account to allow the user to proceed with the service transaction.
